(19) United States
(12) Patent Application Publication
(10) Pub. No.: US 2021/0382289 A1
(43) Pub. Date: Dec. 9, 2021

(54) REFLECTIVE MASTERSURFACE PRIMARY MIRROR, AUXILIARY MIRROR, AND TELESCOPE SYSTEM

(71) Applicant: SOUTHERN UNIVERSITY OF SCIENCE AND TECHNOLOGY, Guangdong (CN)

(72) Inventors: Guixin LI, Guangdong (CN); Xuan LIU, Guangdong (CN); Junhong DENG, Guangdong (CN)

(21) Appl. No.: 17/286,101

(22) PCT Filed: Jan. 24, 2019
(86) PCT No.: PCT/CN2019/072941

§ 371 Date: Apr. 16, 2021

(30) Foreign Application Priority Data
Oct. 18, 2018 (CN) 201811214236.X

(51) Int. Cl. G02B 23/06; G02B 5/09

(52) U.S. Cl. CPC G02B 23/06; G02B 5/09

(57) ABSTRACT

Provided are a reflective metasurface primary mirror and secondary mirror, and a telescope system. The reflective metasurface primary mirror includes a transparent substrate and a primary mirror metasurface functional unit pattern disposed on the transparent substrate. The primary mirror metasurface functional unit pattern includes an anisotropic primary mirror subwavelength structure disposed in a set annular region, and a phase introduced by the primary mirror subwavelength structure satisfies a primary mirror phase distribution. The set annular region encircles a light-transmissive hole, and light reflected by the reflective metasurface secondary mirror is focused through the light-transmissive hole.

### CROSS-REFERENCE TO RELATED APPLICATIONS

This is a National Stage Application filed under 35 U.S.C. 371 based on International Patent Application No. PCT/CN2019/072941, filed on Jan. 24, 2019, which claims priority to Chinese Patent Application No. 201811214236.X filed on Oct. 18, 2018, the disclosures of both of which are incorporated herein by reference in their entireties.

### TECHNICAL FIELD

Embodiments of the present application relate to the technical field of metasurfaces, for example, to a reflective metasurface primary mirror and secondary mirror, and a telescope system.

### BACKGROUND

A Newtonian reflective telescope system, a Cassegrain reflective telescope system, and a Gregorian reflective telescope system are mainly included in traditional reflective telescope systems and each are composed of a primary mirror and a secondary mirror. Ambient light can be focused after sequentially being reflected by the primary mirror and the secondary mirror and imaging can be achieved. The above three reflective telescope systems have their primary mirrors all being concave mirrors and have their secondary mirrors being a plane mirror, a convex mirror and a concave mirror respectively. The successful implementation of these systems requires careful design of curved mirrors therein, and ideal phase tuning and wavefront shaping are achieved through consecutive geometric curvature changes on the surfaces of the curved mirrors. Therefore, to obtain high-quality two-mirror systems, the requirements for mirror grinding, polishing and other manufacturing process are very strict, the processing speed is low, and the cost is high.

In addition, a telescope for astronomical observation requires a telescope system with as large an aperture as possible to collect signals in order to better view weak starlight from distant stars, so that the manufacturing difficulty and cost are further increased. Meanwhile, the difficulty in manufacturing also limits the size of the aperture of the telescope system, thus limiting the ability of astronomical observation. In addition, curved structures often occupy a large volume, which on one hand limits the development of large-aperture space telescope systems, and on the other hand is not conducive to the development of micro telescope systems.

### SUMMARY

In view of the above, the present application provides a reflective metasurface primary mirror and secondary mirror, and a telescope system, to achieve the design of applying a planar reflective metasurface to a reflective telescope system and solve the issues of high manufacturing difficulty, low processing speed, high cost, and large volume of a traditional reflective telescope system.

The present application adopts the technical schemes described below.

In a first aspect, an embodiment of the present application provides a reflective metasurface primary mirror and the reflective metasurface primary mirror includes a transparent substrate and a primary mirror metasurface functional unit pattern disposed on the transparent substrate.

The primary mirror metasurface functional unit pattern satisfies a primary mirror phase distribution, such that ambient incident light is reflected onto a reflective metasurface secondary mirror and reflected and focused by the reflective metasurface secondary mirror.

The primary mirror metasurface functional unit pattern includes a primary mirror metasurface functional structure disposed in a set annular region, the primary mirror metasurface functional structure includes a plurality of primary mirror metasurface functional units, each primary mirror metasurface functional unit includes an anisotropic primary mirror subwavelength structure, and a phase introduced by the primary mirror subwavelength structure satisfies the primary mirror phase distribution; and the set annular region encircles a light-transmissive hole, and light reflected by the reflective metasurface secondary mirror is focused through the light-transmissive hole.

In a second aspect, an embodiment of the present application provides a reflective metasurface secondary mirror and the reflective metasurface secondary mirror includes a transparent substrate and a secondary mirror metasurface functional unit pattern disposed on the transparent substrate.

The secondary mirror metasurface functional unit pattern satisfies a secondary mirror phase distribution, such that incident light reflected by a reflective metasurface primary mirror onto the reflective metasurface secondary mirror is reflected and focused.

The secondary mirror metasurface functional unit pattern includes a secondary mirror metasurface functional structure disposed in a set circular region, the secondary mirror metasurface functional structure includes a plurality of secondary mirror metasurface functional units, each secondary mirror metasurface functional unit includes an anisotropic secondary mirror subwavelength structure, and a phase introduced by the secondary mirror subwavelength structure satisfies the secondary mirror phase distribution; and the set circular region is configured for aligning with a light-transmissive hole in the reflective metasurface primary mirror such that light reflected by the secondary mirror metasurface functional structure is focused through the light-transmissive hole.

In a third aspect, an embodiment of the present application provides a telescope system and the telescope system includes the reflective metasurface primary mirror described in the first aspect and the reflective metasurface secondary mirror described in the second aspect.

A side of the reflective metasurface primary mirror having a primary mirror metasurface functional structure is disposed opposite to a side of the reflective metasurface secondary mirror having a secondary mirror metasurface functional structure, the reflective metasurface primary mirror and the reflective metasurface secondary mirror is spaced by a set distance, and the secondary mirror metasurface functional structure on the reflective metasurface secondary mirror is aligned with the light-transmissive hole in the reflective metasurface primary mirror.

According to the reflective metasurface primary mirror and secondary mirror and the telescope system provided in the present application, an annular primary mirror metasurface functional structure satisfying the primary mirror phase distribution is formed on the transparent substrate of the planar reflective metasurface primary mirror, and a disk-shaped secondary mirror metasurface functional structure satisfying the secondary mirror phase distribution is formed on the transparent substrate of the planar reflective metasurface secondary mirror. Therefore, after the incident light is reflected by the primary mirror metasurface functional structure to the secondary mirror metasurface functional structure, the incident light can be reflected again by the secondary mirror metasurface functional structure and then is focused through the light-transmissive hole in the reflective metasurface primary mirror. Through the combined design of the reflective metasurface primary mirror and the reflective metasurface secondary mirror, the design of the telescope system based on the planar reflective metasurface is thus achieved, and the issues of high manufacturing difficulty, low processing speed, high cost, and large volume of the traditional reflective telescope system are solved. The planar reflective metasurface in the present application is used for replacing the traditional curved mirror and has the advantages of being light, thin, compact and convenient to integrate. The manufacturing process of the metasurface also greatly reduces the manufacturing difficulty of the traditional curved mirror and is conducive to implementing a large-aperture reflective telescope system and a portable and easily integrated micro telescope system.

### BRIEF DESCRIPTION OF DRAWINGS

FIG. 1 is a side view of a traditional reflective telescope system.

FIG. 2 is a schematic diagram illustrating that a planar metasurface mirror reflects incident light according to an embodiment of the present application.

FIG. 3 is a structure view of a metasurface functional unit according to an embodiment of the present application.

FIG. 4 is a side view of a reflective telescope system according to an embodiment of the present application.

FIG. 5 is a top view of a reflective metasurface primary mirror according to an embodiment of the present application.

FIG. 6 is a top view of a reflective metasurface secondary mirror according to an embodiment of the present application.

FIG. 7 is a flowchart of a method for manufacturing a reflective metasurface primary mirror according to an embodiment of the present application.

FIGS. 8 to 12 are side views of the reflective metasurface primary mirror corresponding to all flows of the method for manufacturing the reflective metasurface primary mirror of FIG. 7.

FIG. 13 is a flowchart of a method for manufacturing a reflective metasurface secondary mirror according to an embodiment of the present application.

FIGS. 14 to 19 are side views of the reflective metasurface secondary mirror corresponding to all flows of the method for manufacturing the reflective metasurface secondary mirror of FIG. 13.

### DETAILED DESCRIPTION

The technical schemes of the present application are further described below through embodiments in conjunction with drawings. It is to be understood that the embodiments set forth below are merely intended to illustrate and not to limit the present application. It is also to be noted that, for ease of description, only part, not all, of structures related to the present application are illustrated in the drawings.

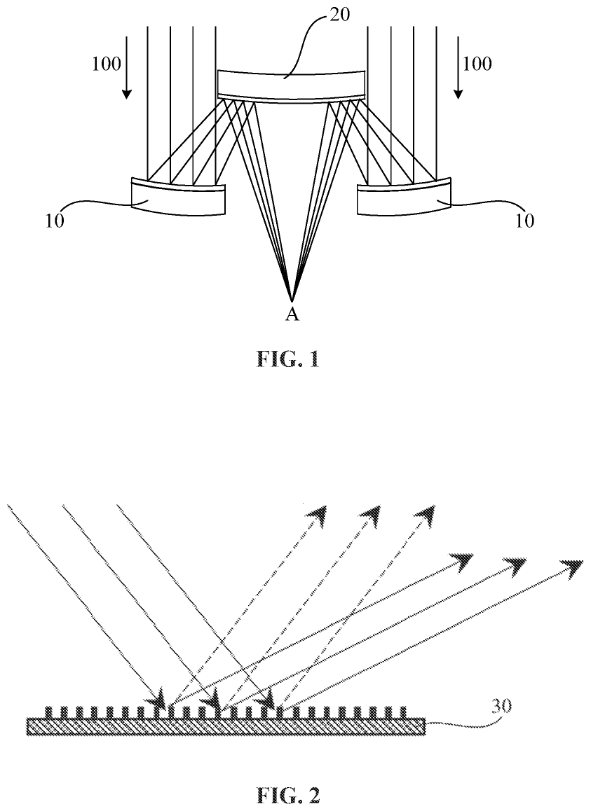

FIG. 1 is a side view of a traditional reflective telescope system. As shown in FIG. 1, the reflective telescope system includes a curved primary mirror 10 and a curved secondary mirror 20; the curved secondary mirror 20 is aligned with the hole in the curved primary mirror 10; and incident light 100 is reflected by a reflective surface of the curved primary mirror 10 onto a reflective surface of the curved secondary mirror 20 and then reflected by the curved secondary mirror 20 and focused to point A through the hole in the curved primary mirror 10. However, the traditional reflective telescope system requires consecutive geometric curvature changes on the reflective surfaces of the curved primary mirror 10 and the curved secondary mirror 20 to achieve ideal phase tuning and wavefront shaping. Therefore, to obtain high-quality reflective focusing, the requirements for grinding, polishing and other manufacturing processes are very strict, the processing speed is low, and the cost is high. Meanwhile, the limited manufacturing of the large-aperture telescope system further limits the ability of astronomical observation. Moreover, the curved reflective mirror often occupies a large volume, which is not conducive to the development of a micro telescope system.

An effective scheme to this issue is provided by the metasurface. The metasurface is an interface formed by subwavelength metasurface functional units with spatial changes. The metasurface functional units are carefully designed so that the polarization, amplitude and phase of electromagnetic waves can be effectively controlled at a subwavelength scale. The two-dimensional properties of the metasurface can achieve electromagnetic functional elements that are more compact, lighter and less lossy. Moreover, the manufacturing process of the metasurface is compatible with the existing complementary metal-oxide-semiconductor technology and is easier to be integrated into the existing optoelectronic technology. Planar elements designed on the basis of metasurfaces are widely applied, for example, in holographic imaging, polarization conversion, spin-orbit angular momentum for generating light, abnormal reflection/refraction, and the like. Among the precision optical elements based on metasurfaces, the most attractive and promising one is a planar lens which may be used as a single lens, used for forming a lens group, and even combined into other more complex optical systems. The metasurface lens makes refractive optical elements light, thin, compact and easy to integrate, and can play a more important role in ultra-small optical devices having more advanced functions. However, the metasurface lens is rarely involved in the telescope system which is an important scientific research tool.

Based on the above, the present application achieves the design of a reflective telescope system by using the planar reflective metasurface. Therefore, the reflective telescope system has the advantages of being light, thin, compact and easy to integrate. Moreover, the manufacturing process of the metasurface also greatly reduces the manufacturing difficulty of the traditional curved mirror and is conducive to achieving mass production and assembly of the reflective telescope system at low cost.

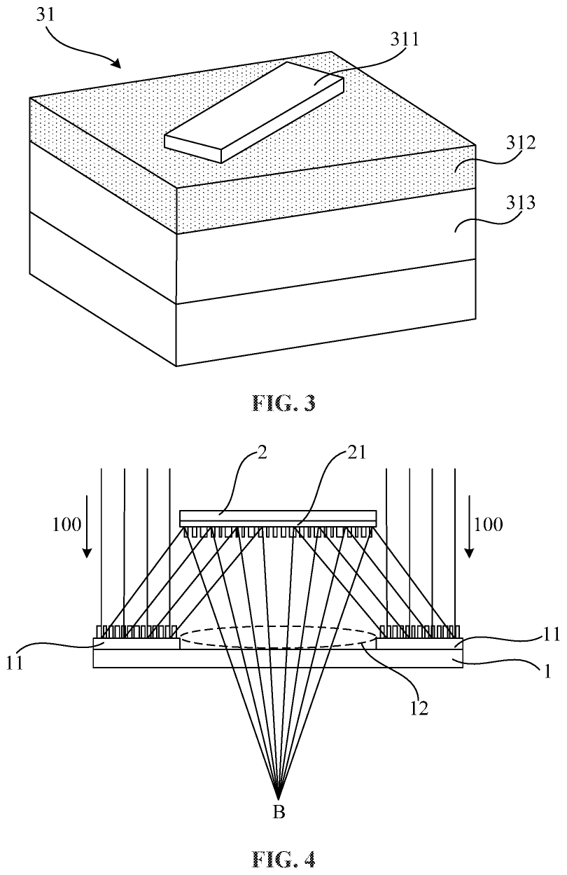

FIG. 2 is a schematic diagram illustrating that a planar metasurface mirror reflects incident light according to an embodiment of the present application; FIG. 3 is a structure view of a metasurface functional unit according to an embodiment of the present application. As shown in FIG. 2, a metasurface mirror 30 is designed according to a general law of reflection. The general law of reflection can be understood as that the component of a wave vector of reflected light along the direction of a reflective interface is equal to the vector sum of the component of a wave vector of incident light along the direction of the reflective interface and an additional phase gradient introduced on the reflective surface. Exemplarily, the metasurface mirror 30 has a gradient phase metasurface; in FIG. 2, dotted arrows represent horizontal mirror surface reflected light and solid arrows represent the gradient phase metasurface reflected light achieved by the metasurface mirror 30. Apparently, the gradient phase metasurface reflected light is deflected relative to the horizontal mirror surface reflected light, which is caused by the additional phase gradient introduced by the metasurface.

As shown in FIG. 3, the metasurface mirror may include a plurality of metasurface functional units 31, and each metasurface functional unit 31 includes at least an anisotropic subwavelength structure 311. According to a Berry geometric phase principle, i.e., the interaction of circularly polarized light and the anisotropic subwavelength structure, the circular polarization state of the incident circularly polarized light can be reversed and meanwhile a geometric phase factor e^{-2iσφ} is introduced, where it σ=±1 represents the circular polarization state of the incident light and φ is the azimuth angle of the anisotropic nanostructure on the plane. It can be seen that a continuous control of the phase, from 0 to 2π, of the incident light can be achieved through a simple change of the azimuth angle of the anisotropic subwavelength structure, and the different phases of the incident light can cause the reflected light to deflect at different angles. Then, the deflection angle of the reflected light can be adjusted through setting of the azimuth angle of the subwavelength structure 311. In an embodiment, the metasurface functional unit 31 may be a structure in which a metal reflective layer 313, a dielectric layer 312, and a subwavelength structure 311 are laminated and may also be a structure in which a metal reflective layer 313 and a subwavelength structure 311 are laminated. The subwavelength structure 311 may be a metal subwavelength structure or a dielectric subwavelength structure, and the subwavelength structure 311 may be of a rod shape or an ellipse shape to achieve higher circularly polarized light conversion efficiency.

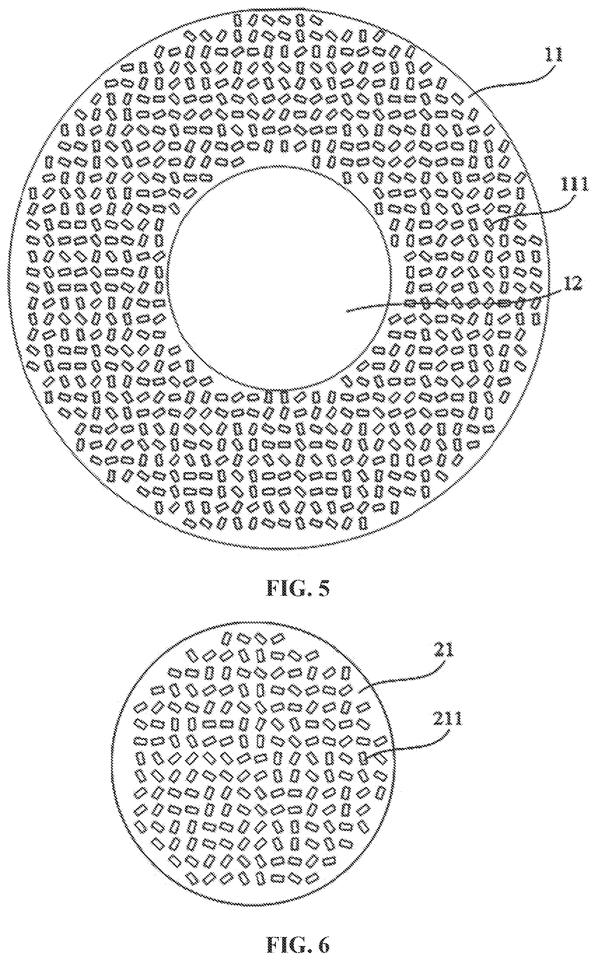

Based on the structure and principle of the metasurface mirror described above, in the present application, the entire metasurface mirror can satisfy a specific phase distribution by setting the azimuth angle of the subwavelength structure of each metasurface functional unit of the metasurface mirror, and at least two metasurface mirrors are used to be combined into a reflective telescope system. Exemplarily, FIG. 4 is a side view of a reflective telescope system according to an embodiment of the present application. As shown in FIG. 4, the reflective telescope system includes a reflective metasurface primary mirror 1 and a reflective metasurface secondary mirror 2 which are disposed opposite to each other and spaced a certain distance apart. In conjunction with FIGS. 5 and 6, the reflective metasurface primary mirror 1 includes an annular primary mirror metasurface functional structure 11 and a circular light-transmissive hole 12 encircled by the primary mirror metasurface functional structure 11. The primary mirror metasurface functional structure 11 includes a plurality of primary mirror metasurface functional units (not shown in FIG. 5, with reference to the structure of the metasurface functional unit in FIG. 3), and the primary mirror metasurface functional unit includes a primary mirror subwavelength structure 111 arranged on the primary mirror metasurface functional structure 11 at a specific azimuth angle. The reflective metasurface secondary mirror 2 includes a disk-shaped secondary mirror metasurface functional structure 21, the secondary mirror metasurface functional structure 21 includes a plurality of secondary mirror metasurface functional units (not shown in FIG. 6, with reference to the structure of the metasurface functional unit in FIG. 3), and the secondary mirror metasurface functional unit includes a secondary mirror subwavelength structure 211 arranged on the secondary mirror metasurface functional structure 21 at a specific azimuth angle. The side of the reflective metasurface primary mirror 1 having the primary mirror metasurface functional structure 11 is disposed opposite to the side of the reflective metasurface secondary mirror 2 having the secondary mirror metasurface functional structure 21, and the secondary mirror metasurface functional structure 21 on the reflective metasurface secondary mirror 2 is aligned with the light-transmissive hole 12 in the reflective metasurface primary mirror 1. The incident light 100 arrived on the primary mirror metasurface functional structure 11 is reflected in a specific direction due to the additional phase gradient introduced by the primary mirror subwavelength structure 111 and is reflected onto the secondary mirror metasurface functional structure 21. Then, the additional phase gradient introduced by the secondary mirror subwavelength structure 211 causes the reflected light formed through reflection by the reflective metasurface primary mirror 1 to be focused at point B through the light-transmissive hole 12. Therefore, in this embodiment, the design of the reflective telescope system can be achieved by combining the reflective metasurface primary mirror 1 and the reflective metasurface secondary mirror 2.

Exemplarily, with reference to FIGS. 5 and 12, the reflective metasurface primary mirror includes a transparent substrate 201 and a primary mirror metasurface functional unit pattern disposed on the transparent substrate 201.

The primary mirror metasurface functional unit pattern satisfies a primary mirror phase distribution, such that ambient incident light is reflected onto a reflective metasurface secondary mirror and reflected and focused by the reflective metasurface secondary mirror.

The primary mirror metasurface functional unit pattern includes the primary mirror metasurface functional structure 11 disposed in a set annular region, the primary mirror metasurface functional structure 11 includes a plurality of primary mirror metasurface functional units, the primary mirror metasurface functional unit includes the anisotropic primary mirror subwavelength structure 111, and a phase introduced by the primary mirror subwavelength structure 111 satisfies the primary mirror phase distribution; and the set annular region encircles the light-transmissive hole 12, and light reflected by the reflective metasurface secondary mirror is focused through the light-transmissive hole 12.

In this embodiment, the primary mirror phase distribution may be designed according to the geometric shape of a curved mirror, a Gregorian reflective telescope system, is Cassegrain reflective telescope system, or a Newton reflective telescope system.

For the reflective metasurface primary mirror designed according to the Newton reflective telescope system, the primary mirror phase distribution is determined according to a first set parameter combined with ray optics and the general law of reflection, where the first set parameter includes an aperture of the primary mirror, a focal ratio of a system, and an operating wavelength of the system. In this case, it is merely necessary to determine the focusing characteristics of the reflective metasurface primary mirror. The reflective metasurface secondary mirror is a traditional planar mirror and is merely used for changing the direction of propagation of the light reflected by the reflective metasurface primary mirror and adjusting the position of focus.

For the reflective metasurface primary mirror designed according to the Cassegrairi reflective telescope system or the Gregorian reflective telescope system, the primary mirror phase distribution is determined according to a second set parameter combined with ray optics and the general law of reflection, where the second set parameter includes an aperture of the primary mirror, a focal ratio of the primary mirror, a focal ratio of a system, a distance from focus of the system to the primary mirror, an operating wavelength of the system, and a mapping relationship between a position where the incident light arrives on the reflective metasurface primary mirror and a position where the incident light reflected by the reflective metasurface primary mirror arrives on the reflective metasurface secondary mirror. In this embodiment, the optical path of the incident light after entering the telescope system may be determined according to the second set parameter, and the additional phase gradient to be introduced at each position of the reflective metasurface primary mirror may be determined in conjunction with the ray optics and the general law of reflection. Thus, the primary mirror phase distribution of the entire reflective metasurface primary mirror may be determined.

The primary mirror phase distribution may also be determined according to a geometric shape of a curved primary mirror in a set reflective telescope system. The set reflective telescope system may be any existing curved reflective telescope system or a curved reflective telescope system set according to requirements. In this embodiment, the phase of the corresponding position on the reflective metasurface primary mirror of the present application may be determined according to the phase tuning effect of the curved primary mirror in the set curved reflective telescope system on light, and thus the primary mirror phase distribution of the entire reflective metasurface primary mirror is determined. Exemplarily, the curved reflective telescope system may be a Ritchey-Chrétien telescope system in which coma and spherical aberration on a focal plane can be effectively eliminated. Exemplarily, the phase distribution to be introduced on the reflective metasurface primary mirror may be determined according to the direction angle of the reflected light at each position of the curved primary mirror where parallel light is normal incident and in conjunction with the general law of reflection.

In an embodiment, the primary mirror metasurface functional unit may include a structure in which a metal reflective layer, a dielectric layer, and an anisotropic metal subwavelength structure are laminated; or the primary mirror metasurface functional unit includes a structure in which a metal reflective layer and an anisotropic metal primary mirror subwavelength structure are laminated; or a structure in which a metal reflective layer and an anisotropic dielectric primary mirror subwavelength structure are laminated.

In an embodiment, for the reflective metasurface primary mirror designed according to the Berry geometric phase principle, the azimuth angles of the primary mirror subwavelength structures corresponding to different phases are different, i.e., the azimuth angles of the primary mirror subwavelength structures at different positions are set according to the required phase distribution, such that the incident light is reflected by the reflective metasurface primary mirror to the corresponding positions of the reflective metasurface secondary mirror.

In an embodiment, the primary mirror subwavelength structure may be of a rod shape and/or an ellipse shape to achieve higher circularly polarized light conversion efficiency. Exemplarily, when the primary mirror metasurface functional unit includes the structure in which a metal reflective layer, a dielectric layer, and a metal subwavelength structure are laminated, the metal reflective layer and the metal subwavelength structure are made of gold, and the dielectric layer is made of silicon dioxide; when the metal subwavelength structure is of the rod shape, the circularly polarized light conversion efficiency can be as high as 80% in the near-infrared band.

Exemplarily, with reference to FIGS. 6 and 19, the reflective metasurface secondary mirror may include a transparent substrate 200 and a secondary mirror metasurface functional unit pattern disposed on the transparent substrate 200.

The secondary mirror metasurface functional unit pattern satisfies a secondary mirror phase distribution, such that incident light reflected by a reflective metasurface primary mirror onto the reflective metasurface secondary mirror is reflected and focused.

The secondary mirror metasurface functional unit pattern includes a secondary mirror metasurface functional structure 21 disposed in a set circular region, the secondary mirror metasurface functional structure 21 includes a plurality of secondary mirror metasurface functional units, the secondary mirror metasurface functional unit includes an anisotropic secondary mirror subwavelength structure 211, and a phase introduced by the secondary mirror subwavelength structure 211 satisfies the secondary mirror phase distribution; and the set circular region is configured for aligning with a light-transmissive hole in the reflective metasurface primary mirror such that light reflected by the secondary mirror metasurface functional structure is focused through the light-transmissive hole.

In this embodiment, the primary mirror phase distribution may be designed according to the geometric shape of a curved mirror, a Gregorian reflective telescope system, or a Cassegrain reflective telescope system.

For the reflective metasurface secondary mirror designed according to the Cassegrain reflective telescope system or the Gregorian reflective telescope system, the secondary mirror phase distribution is determined according to a third set parameter combined with ray optics and the general law of reflection; where the third set parameter includes an aperture of the secondary mirror, a focal ratio of the secondary mirror, a focal ratio of a system, a distance from focus of the system to the secondary mirror, an operating wavelength of the system, and a mapping relationship a position where incident light arrives on the reflective metasurface primary mirror and a position where the incident light reflected by the reflective metasurface primary mirror arrives on the reflective metasurface secondary mirror. In this embodiment, the optical path of the incident light after entering the system may be determined according to the third set parameter, and the additional phase gradient to be introduced at each position of the reflective metasurface secondary mirror may be determined in conjunction with the ray optics and the general law of reflection. Thus, the secondary mirror phase distribution of the entire reflective metasurface secondary mirror may be determined.

The secondary mirror phase distribution may also be determined according to a geometric shape of a curved secondary mirror in a set reflective telescope system. In this embodiment, the phase of the corresponding position on the reflective metasurface secondary mirror of the present application may be determined according to the phase tuning effect of the curved secondary mirror in the set curved reflective telescope system on light, and thus the secondary mirror phase distribution of the entire reflective metasurface secondary mirror is determined. Exemplarily, the curved reflective telescope system may be a traditional Ritchey-Chrétien telescope system in which coma and spherical aberration on a focal plane can be effectively eliminated. Exemplarily, the phase distribution to be introduced on the reflective metasurface secondary mirror may be determined according to the direction angle of the reflected light at each position of the curved secondary mirror where parallel light is normal incident and in conjunction with the general law of reflection.

In an embodiment, the secondary mirror metasurface functional unit may include a structure in which a metal reflective layer, a dielectric layer, and an anisotropic metal subwavelength structure are laminated; or the secondary mirror metasurface functional unit includes a structure in which a metal reflective layer and an anisotropic metal secondary mirror subwavelength structure are laminated; or a structure in which a metal reflective layer and an anisotropic dielectric secondary mirror subwavelength structure are laminated.

In an embodiment, for the reflective metasurface secondary mirror designed according to the Berry geometric phase principle, the azimuth angles of the secondary mirror subwavelength structures corresponding to different phases are different, i.e., the azimuth angles of the secondary mirror subwavelength structures at different positions are set according to the required phase distribution, to achieve that light is reflected and focused by the reflective metasurface secondary mirror.

In an embodiment, the secondary mirror subwavelength structure may be of a rod shape and/or an ellipse shape to achieve higher circularly polarized light conversion efficiency.

The telescope system provided in the embodiments of the present application includes the reflective metasurface primary mirror and the reflective metasurface secondary mirror. The annular primary mirror metasurface functional structure satisfying the primary mirror phase distribution is formed on the transparent substrate of the planar reflective metasurface primary mirror, and the disk-shaped secondary mirror metasurface functional structure satisfying the secondary mirror phase distribution is formed on the transparent substrate of the planar reflective metasurface secondary mirror. Therefore, after the incident light is reflected by the primary mirror metasurface functional structure to the secondary mirror metasurface functional structure, the incident light can be reflected again by the secondary mirror metasurface functional structure, and then is focused through the light-transmissive hole in the reflective metasurface primary mirror. Through the combined design of the reflective metasurface primary mirror and the reflective metasurface secondary mirror, the design of the telescope system based on the planar reflective metasurface is thus achieved, and the issues of high manufacturing difficulty, low processing speed, high cost, and large volume of the traditional reflective telescope system are solved. The planar reflective metasurface in the present application is used for replacing the traditional curved mirror and has the advantages of being light, thin, compact and convenient to integrate. The manufacturing process of the metasurface also greatly reduces the manufacturing difficulty of the traditional curved mirror and is conducive to implementing a large-aperture reflective telescope system and a portable and easily integrated micro telescope system.

In addition, a method for manufacturing a reflective metasurface primary mirror and a method for manufacturing a reflective metasurface secondary mirror are further provided in the embodiments of the present application.

This embodiment is illustrated by using an example in which a primary mirror metasurface functional unit and a secondary mirror metasurface functional unit each include a structure in which a metal reflective layer, a dielectric layer, and an anisotropic metal subwavelength structure are laminated.

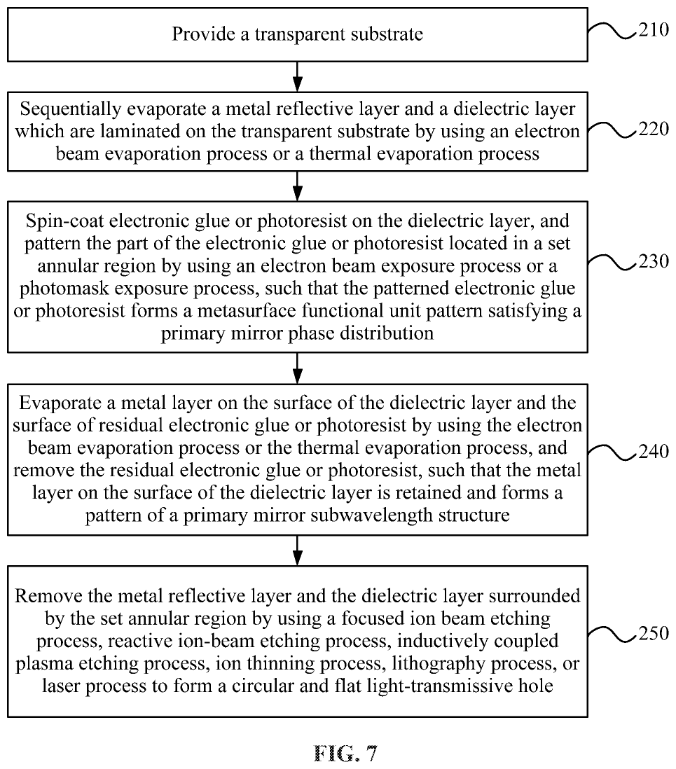

FIG. 7 is a flowchart of a method for manufacturing a reflective metasurface primary mirror according to an embodiment of the present application. As shown in FIG. 7, the method for manufacturing a reflective metasurface primary mirror includes steps described below.

In step 210, a transparent substrate is provided.

Exemplarily, a transparent substrate: in a corresponding operating waveband is selected according to the material of a primary mirror metasurface functional unit pattern on the transparent substrate so as to accommodate incident light in different operating wavebands.

In step 220, a metal reflective layer and a dielectric layer which are laminated are sequentially evaporated on the transparent substrate by using an electron beam evaporation process or a thermal evaporation process.

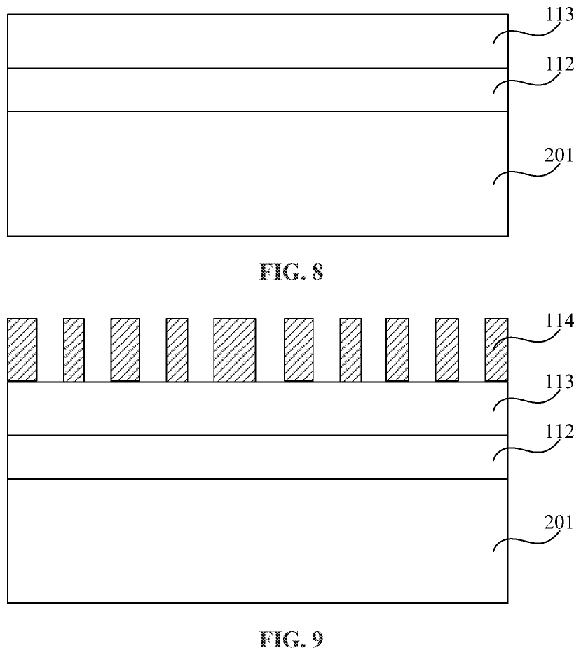

Exemplarily, with reference to FIG. 8, a metal reflective layer 112 may be evaporated on a transparent substrate 201 by using the electron beam evaporation process, and then a dielectric layer 113 may be evaporated on the metal reflective layer 112 by using the thermal evaporation process. The materials of the metal reflective layer 112 and the dielectric layer 113 may be selected according to the operating waveband of the system. For example, in a visible near-infrared band, the metal reflective layer 112 may be made of gold, silver, aluminum, or another metal material, and the dielectric layer 113 may be made of silicon dioxide or titanium dioxide; in an infrared band, the metal reflective layer 112 may be made of gold, silver, aluminum, silicon dioxide, or titanium dioxide, and the dielectric layer 113 may be made of CaF₂, MgF₂, Ge, polytetrafluoroethylene, or another medium; in a microwave band, the metal reflective layer 112 may be made of gold, silver, aluminum, copper, or another metal material, and the dielectric layer 113 may be made of a transparent ceramic or the like.

In step 230, electronic glue or photoresist is spin-coated on the dielectric layer, and the part of the electronic glue or photoresist located in a set annular region is patterned by using an electron beam exposure process or a photomask exposure process, such that the patterned electronic glue or photoresist forms a metasurface functional unit pattern satisfying a primary mirror phase distribution.

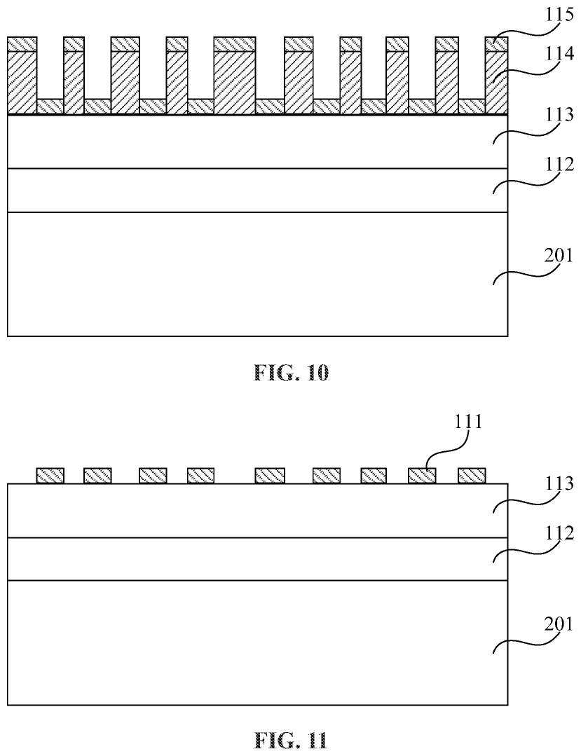

Exemplarily, referring to FIG. 9, photoresist 114 is spin-coated on the dielectric layer 113, and the part of the photoresist 114 located in the set annular region is patterned by using the electron beam exposure process or the photomask exposure process (or all of the photoresist 114 may be patterned and merely the patterned photoresist located in the set annular region satisfies the primary mirror phase distribution), such that the patterned photoresist satisfies the primary mirror phase distribution. The set annular region is a region encircling a light-transmissive hole, and the diameter of the inner hole of the annular region may be designed according to the set size of a reflective metasurface secondary mirror.

In this embodiment, the electronic glue should be patterned by using electron beam lithography and the photoresist should be patterned by using ultraviolet lithography. The dimensions of the subsequently formed primary mirror subwavelength structure are different for different operating bands, and the lithography process used in this step will also be different. For example, in a visible light band, the electron beam lithography is mostly used; in the infrared band, the ultraviolet lithography may be selected. In addition, in the microwave band, a printed circuit board technology may be adopted.

In step 240, a metal layer is evaporated on the surface of the dielectric layer and the surface of the residual electronic glue or photoresist by using the electron beam evaporation process or the thermal evaporation process, and the residual electronic glue or photoresist is removed, such that the metal layer on the surface of the dielectric layer is retained and forms a pattern of the primary mirror subwavelength structure.

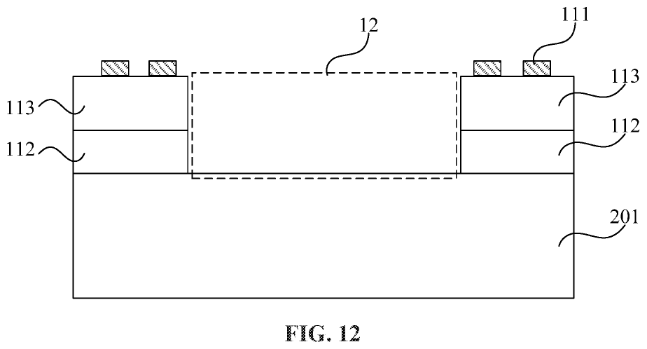

Exemplarily, referring to FIG. 10, a metal layer 115 may be evaporated on the surface of the dielectric layer 113 and the surface of residual photoresist 114 (patterned photoresist) by using the electron beam evaporation process, where the opening of the residual photoresist 114 defines the shape, dimension, and azimuth angle of the primary mirror subwavelength structure formed on the surface of the dielectric layer 113. Referring to FIG. 11, the residual photoresist 114 is removed by using the corresponding glue removing solution, the metal layer 115 formed on the surface of the residual photoresist 114 is simultaneously peeled off, and the metal layer on the surface of the dielectric layer 113 is retained, such that the primary mirror subwavelength structure 111 is formed.

In step 250, the metal reflective layer and the dielectric layer surrounded by the set annular region are removed by using a focused ion beam etching process, reactive ion-beam etching process, inductively coupled plasma etching process, ion thinning process, lithography process, or laser process to form a circular and flat light-transmissive hole.

Exemplarily, referring to FIG. 12, any one of the focused ion beam etching process, reactive ion-beam etching process, inductively coupled plasma etching process, ion thinning process, lithography process, or laser process may he used for removing the metal reflective layer 112 and the dielectric layer 113 in the region corresponding to the light-transmissive hole to be formed, such that a circular and flat light-transmissive hole 12 is formed, and the annular primary mirror metasurface functional structure is simultaneously formed. Thus, the manufacturing of the reflective metasurface primary mirror is completed.

In an embodiment, the step in which the part of the electronic glue or photoresist located in the set annular region is patterned by using the lithography process may further include a step described below.

The part of the electronic glue or photoresist located in the set annular region is patterned by using the electron beam exposure process or the photomask exposure process based on a theory of surface plasmon resonance or nanostructure scattering.

Through adjustment of the geometric dimension of the subsequently formed primary mirror subwavelength structure, high optical reflection efficiency is achieved in a required operating band, and thus the utilization rate of incident light is improved, the loss of the incident light is reduced, and the imaging quality of a focusing and imaging system can be improved.

Accordingly, a reflective metasurface primary mirror is provided in an embodiment of the present application and can be manufactured by using the method for manufacturing a reflective metasurface primary mirror provided by any embodiment of the present application. The reflective metasurface primary mirror includes a transparent substrate and a primary mirror metasurface functional unit pattern disposed on the transparent substrate. The primary mirror metasurface functional unit pattern satisfies a primary mirror phase distribution, such that incident light reflected by a reflective metasurface secondary mirror onto the reflective metasurface primary mirror is reflected and focused.

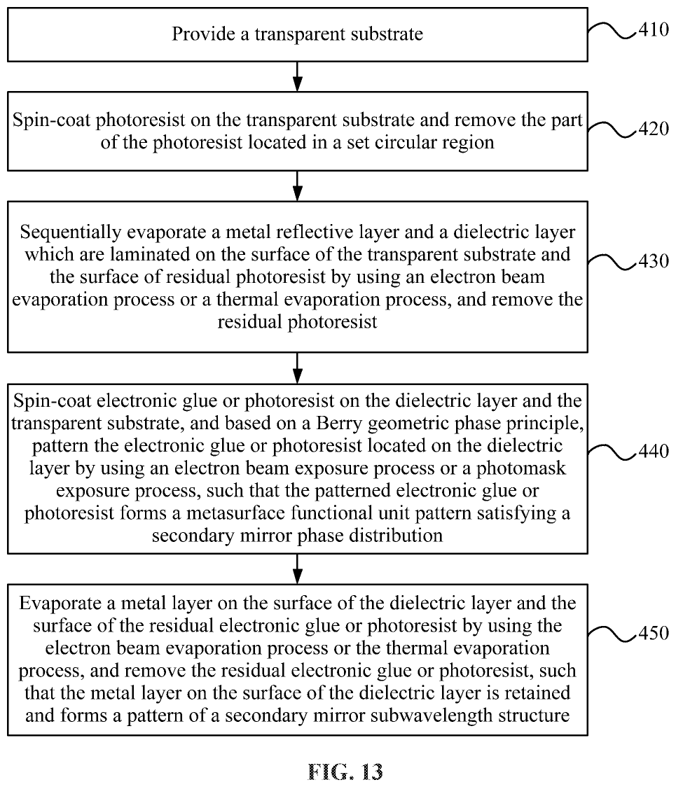

In addition, FIG. 13 is a flowchart of a method for manufacturing a reflective metasurface secondary mirror according to an embodiment of the present application. As shown in FIG. 13, the method for manufacturing a reflective metasurface secondary mirror includes steps described below.

In step 410, a transparent substrate is provided.

Exemplarily, a transparent substrate in a corresponding operating waveband is selected according to the material of a secondary mirror metasurface functional unit pattern on the transparent substrate so as to accommodate incident light in different operating wavebands.

In step 420, photoresist is spin-coated on the transparent substrate and the part of the photoresist located in a set circular region is removed.

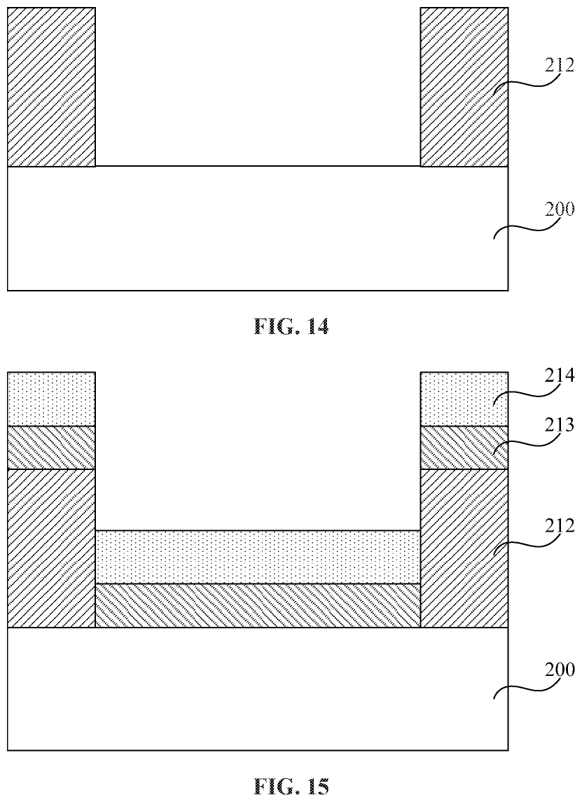

Exemplarily, referring to FIG. 14, photoresist 212 is spin-coated on a transparent substrate 200, exposed by using a mask having the same opening as the set circular region, and developed in a developer; the part of the photoresist 212 located in the set circular region is removed. The set circular region corresponds to a light-transmissive hole of the reflective metasurface primary mirror.

In step 430, a metal reflective layer and a dielectric layer which are laminated are sequentially evaporated on the surface of the transparent substrate and the surface of residual photoresist by using an electron beam evaporation process or a thermal evaporation process, and the residual photoresist is removed.

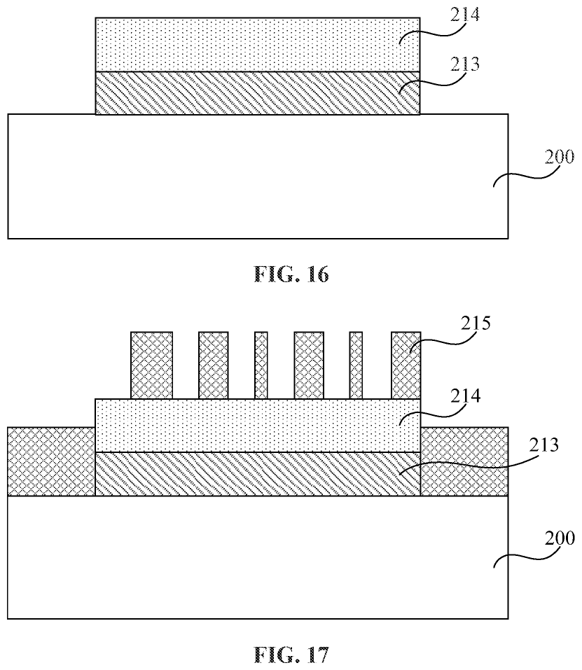

Exemplarily, referring to FIG. 15, a metal reflective layer 213 may be evaporated on the surface of the transparent substrate 200 and the surface of residual photoresist 212 by using the electron beam evaporation process, and then a dielectric layer 214 may be evaporated on the surface of the metal reflective layer 213 by using the thermal evaporation process. The materials of the metal reflective layer 213 and the dielectric layer 214 may be selected according to the operating waveband of the system. For example, in a visible near-infrared band, the metal reflective layer 213 may be made of gold, silver, aluminum, or another metal material, and the dielectric layer 214 may be made of silicon dioxide or titanium dioxide; in an infrared hand, the metal reflective layer 213 may be made of gold, silver, aluminum, silicon dioxide, or titanium dioxide, and the dielectric layer 214 may be made of CaF₂, MgF₂, Ge, polytetrafluoroethylene, or another medium; in a microwave band, the metal reflective layer 213 may be made of gold, silver, copper, aluminum, or another metal material, and the dielectric layer 214 may be made of a transparent ceramic or the like. Referring to FIG. 16, the residual photoresist 212 is then removed by using the corresponding glue removing solution, and a structure in which the metal reflective layer 213 and the dielectric layer 214 are laminated is formed in the set circular region.

In step 440, electronic glue or photoresist is spin-coated on the dielectric layer and the transparent substrate, and based on the Berry geometric phase principle, the electronic glue or photoresist located on the dielectric layer is patterned by using an electron beam exposure process or a photomask exposure process, such that the patterned electronic glue or photoresist forms a metasurface functional unit pattern satisfying secondary mirror phase distribution.

Exemplarily, referring to FIG. 17, photoresist 215 is spin-coated on the dielectric layer 212 and the exposed transparent substrate 200. Based on the Berry geometric phase principle, the part of the photoresist 215 located in the set circular region is patterned by using a lithography process such that the patterned photoresist 215 satisfies the secondary mirror phase distribution.

In this embodiment, the electronic glue should be patterned by using electron beam lithography, and the photoresist should be patterned by using ultraviolet lithography. The dimensions of the subsequently formed primary mirror sub wavelength structure are different for different operating bands, and the lithography process used in this step will also be different. For example, in a visible light band, the electron beam lithography is mostly used; in the infrared band, the ultraviolet lithography may be selected. In addition, in the microwave band, a printed circuit board technology may be adopted.

In step 450, a metal layer is evaporated on the surface of the dielectric layer and the surface of the residual electronic glue or photoresist by using the electron beam evaporation process or the thermal evaporation process, and the residual electronic glue or photoresist is removed, such that the metal layer on the surface of the dielectric layer is retained and forms a pattern of a secondary mirror subwavelength structure.

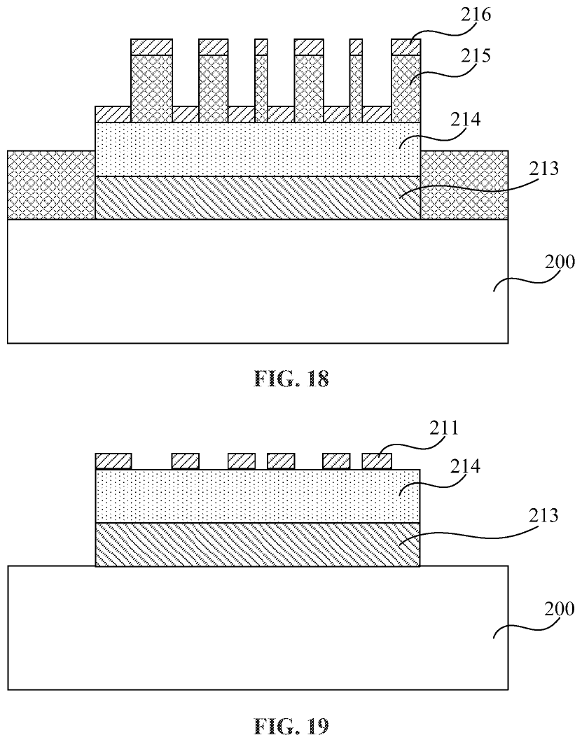

Exemplarily, referring to FIG. 18, a metal layer 216 may he evaporated on the surface of the dielectric layer 214 and the surface of residual photoresist 215 (patterned photoresist) by using the electron beam evaporation process, where the opening of the residual photoresist 215 defines the shape, dimension, and azimuth angle of the secondary mirror subwavelength structure formed on the surface of the dielectric layer 214. Referring to FIG. 19, the residual photoresist 215 is removed by the corresponding glue removing solution, the metal layer 216 formed on the surface of the residual photoresist 215 is simultaneously peeled off, and the metal layer on the surface of the dielectric layer 214 is retained, such that the secondary mirror subwavelength structure 211 is formed and the manufacturing of the reflective metasurface secondary mirror is completed.

In an embodiment, the step in which the electronic glue or photoresist located on the dielectric layer is patterned by using the lithography process may further include a step described below.

The electronic glue or photoresist located on the dielectric layer is patterned by using the lithography process based on the theory of surface plasmon resonance or nanostructure scattering.

Through adjustment of the geometric dimension of the subsequently formed secondary mirror subwavelength structure, high optical reflection efficiency is achieved in a required operating band, and thus the utilization rate of incident light is improved, the loss of the incident light is reduced, and the imaging quality of a focusing and imaging system can be improved.

1. A reflective metasurface primary mirror, comprising:
a transparent substrate; and
a primary mirror metasurface functional unit pattern disposed on the transparent substrate, wherein the primary mirror metasurface functional unit pattern satisfies a primary mirror phase distribution, such that ambient incident light is reflected onto a reflective metasurface secondary mirror and reflected and focused by the reflective metasurface secondary mirror;
wherein the primary mirror metasurface functional unit pattern comprises a primary mirror metasurface functional structure disposed in a set annular region, the primary mirror metasurface functional structure comprises a plurality of primary mirror metasurface functional units, each primary mirror metasurface functional unit comprises an anisotropic primary mirror subwavelength structure, and a phase introduced by the primary mirror subwavelength structure satisfies the primary mirror phase distribution; and the set annular region encircles a light-transmissive hole, and light reflected by the reflective metasurface secondary mirror is focused through the light-transmissive hole.

2. The reflective metasurface primary mirror of claim 1, wherein the reflective metasurface primary mirror is a primary mirror designed according to a Newtonian reflective telescope system, and the primary mirror phase distribution is determined according to a first set parameter combined with ray optics and a general law of reflection, wherein the first set parameter comprises an aperture of the primary mirror, a focal ratio of a system and an operating wavelength of the system; or
the reflective primary minor is a primary minor designed according to a Cassegrain reflective telescope system or a Gregorian reflective telescope system, and the primary mirror phase distribution is determined according to a second set parameter combined with ray optics and a general law of reflection, wherein the second set parameter comprises an aperture of the primary mirror, a focal ratio of the primary mirror, a focal ratio of a system, a distance from focus of the system to the primary mirror, an operating wavelength of the system, and a mapping relationship between a position where incident light arrives on the reflective metasurface primary mirror and a position where the incident light reflected by the reflective metasurface primary mirror arrives on the reflective metasurface secondary mirror; or
the primary mirror phase distribution is determined according to a geometric shape of a curved primary mirror in a set reflective telescope system.

3. The reflective metasurface primary mirror of claim 1, wherein each primary mirror metasurface functional unit comprises one of following laminated structures:
a structure in which a metal reflective layer, a dielectric layer, and an anisotropic metal subwavelength structure are laminated;
a structure in which a metal reflective layer and an anisotropic metal primary mirror subwavelength structure are laminated; or
a structure in which a metal reflective layer and an anisotropic dielectric primary mirror subwavelength structure are laminated.

4. The reflective metasurface primary mirror of claim 1, wherein the reflective metasurface primary mirror is a primary mirror designed according to a Berry geometric phase principle, and azimuth angles of primary mirror subwavelength structures corresponding to different phases involved in the primary mirror phase distribution are different.

5. The reflective metasurface primary mirror of claim 4, wherein the primary mirror subwavelength structures comprise at least one of a rod shape or an ellipse shape.

6. A reflective metasurface secondary mirror, comprising:
a transparent substrate; and
a secondary minor metasurface functional unit pattern disposed on the transparent substrate, wherein the secondary mirror metasurface functional unit pattern satisfies a secondary mirror phase distribution, such that incident light reflected by a reflective metasurface primary minor onto the reflective metasurface secondary mirror is reflected and focused;
wherein the secondary mirror metasurface functional unit pattern comprises a secondary mirror metasurface functional structure disposed in a set circular region, the secondary mirror metasurface functional structure comprises a plurality of secondary mirror metasurface functional units, each secondary mirror metasurface functional unit comprises an anisotropic secondary minor subwavelength structure, and a phase introduced by the secondary mirror subwavelength structure satisfies the secondary mirror phase distribution; and the set circular region is configured for aligning with a light-transmissive hole in the reflective metasurface primary mirror such that light reflected by the secondary minor metasurface functional structure is focused through the light-transmissive hole.

7. The reflective metasurface secondary mirror of claim 6, wherein the reflective metasurface secondary mirror is a secondary mirror designed according to a Cassegrain reflective telescope system or a Gregorian reflective telescope system, and the secondary mirror phase distribution is determined according to a third set parameter combined with ray optics and a general law of reflection, wherein the third set parameter comprises an aperture of the secondary mirror, a focal ratio of the secondary mirror, a focal ratio of a system, a distance from focus of the system to the secondary mirror, an operating wavelength of the system, and a mapping relationship between a position where incident light arrives on the reflective metasurface primary mirror and a position where the incident light reflected by the reflective metasurface primary mirror arrives on the reflective metasurface secondary mirror; or
the secondary mirror phase distribution is determined according to a geometric shape of a curved secondary mirror in a set reflective telescope system.

8. The reflective metasurface secondary mirror of claim 6, wherein each secondary mirror metasurface functional unit comprises one of following laminated structures:
a structure in which a metal reflective layer, a dielectric layer, and an anisotropic metal subwavelength structure are laminated;
a structure in which a metal reflective layer and an anisotropic metal secondary minor subwavelength structure are laminated; or
a structure in which a metal reflective layer and an anisotropic dielectric secondary mirror subwavelength structure are laminated.

9. The reflective metasurface secondary mirror of claim 6, wherein the reflective metasurface secondary mirror is a secondary mirror designed according to a Berry geometric phase principle, and azimuth angles of secondary mirror subwavelength structures corresponding to different phases involved in the secondary mirror phase distribution are different.

10. The reflective metasurface secondary minor of claim 9, wherein the secondary mirror subwavelength structures comprise at least one of a rod shape or an ellipse shape.

11. A telescope system, comprising a reflective metasurface primary mirror and a reflective metasurface secondary mirror;
wherein the reflective metasurface primary mirror comprises:
a transparent substrate: and
a primary mirror metasurface functional unit pattern disposed on the transparent substrate, wherein the primary mirror metasurface functional unit pattern satisfies a primary mirror phase distribution such that ambient incident light is reflected onto a reflective metasurface secondary mirror and reflected and focused by the reflective metasurface secondary mirror;
wherein the primary mirror metasurface functional unit pattern comprises a primary mirror metasurface functional structure disposed in a set annular region, the primary mirror metasurface functional structure comprises a plurality of primary mirror metasurface functional units, each primary minor metasurface functional unit comprises an anisotropic primary mirror subwavelength structure, and a phase introduced by the primary mirror subwavelength structure satisfies the primary mirror phase distribution; and the set annular region encircles a light-transmissive hole, and light reflected by the reflective metasurface secondary minor is focused through the light-transmissive hole;
wherein reflective metasurface secondary mirror comprises:
a transparent substrate; and
a secondary mirror metasurface functional unit pattern disposed on the transparent substrate, wherein the secondary mirror metasurface functional unit pattern satisfies a secondary mirror phase distribution, such that incident light reflected by a reflective metasurface primary mirror onto the reflective metasurface secondary mirror is reflected and focused;
wherein the secondary mirror metasurface functional unit pattern comprises a secondary mirror metasurface functional structure disposed in a set circular region, the secondary mirror metasurface functional structure comprises a plurality of secondary mirror metasurface functional units, each secondary mirror metasurface functional unit comprises an anisotropic secondary minor subwavelengh structure, and a phase introduced by the secondary mirror subwavelength structure satisfies the secondary mirror phase distribution;
and the set circular region is configured for aligning with a light-transmissive hole in the reflective metasurface primary mirror such that, light reflected by the secondary mirror metasurface functional structure is focused through the light-transmissive hole; and
wherein a side of the reflective metasurface primary mirror having the primary mirror metasurface functional structure is disposed opposite to a side of the reflective metasurface secondary mirror having the secondary mirror metasurface functional structure, the reflective metasurface primary mirror and the reflective metasurface secondary mirror are spaced by a set distance, and the secondary mirror metasurface functional structure on the reflective metasurface secondary mirror is aligned with the light-transmissive hole in the reflective metasurface primary mirror.
